(19) United States
(12) Patent Application Publication
(10) Pub. No.: US 2025/0168099 A1
(43) Pub. Date: May 22, 2025

(54) MECHANISM TO OPTIMIZE MASS SWITCHING TRIGGERED BY CLOUD DC SITE FAILURES OR DEGRADATION

(71) Applicant: HUAWEI TECHNOLOGIES CO., LTD., Shenzhen (CN)

(72) Inventors: Linda Dunbar, Plano, TX (US); Donald Eggleston Eastlake, III, Apopka, FL (US)

(21) Appl. No.: 19/033,765

(22) Filed: Jan. 22, 2025

Related U.S. Application Data
(63) Continuation of application No. PCT/US2023/028269, filed on Jul. 20, 2023.
(60) Provisional application No. 63/391,370, filed on Jul. 22, 2022.

(51) Int. Cl. H04L 45/02; H04L 69/325

(52) U.S. Cl. CPC H04L 45/02; H04L 69/325

(57) ABSTRACT

A method performed by an ingress router of an edge cloud data center to optimize mass switching triggered by site failures or degradation at the data center. The method includes receiving a Border Gateway Protocol (BGP) UPDATE message that includes a site-reference identifier (ID) and operating capacity information, where the site-reference ID corresponds to a group of routes within a site of the cloud data center; attaching the site-reference ID to the group of routes in a routing table; selecting a path for forwarding traffic corresponding to the group of routes based on the operating capacity information; and forwarding traffic for selected services along the path.

### CROSS-REFERENCE TO RELATED APPLICATION

This application is a continuation of International Patent Application No. PCT/US2023/028269 filed on Jul. 20, 2023, which claims the benefit of U.S. Provisional Patent Application No. 63/391,370 filed on Jul. 22, 2022. The disclosures of the aforementioned applications are hereby incorporated by reference in their entireties.

### TECHNICAL FIELD

The present disclosure is generally related to network communications, and in particular to techniques for optimizing mass switching triggered by cloud data center (DC) site failures or degradation.

### BACKGROUND

Fifth generation (5G) edge computing enables cloud servers to run and provide services closer to endpoints, reducing latency and speeding up local processing. A cloud data center (DC) gateway (GW) router connects external clients with multiple sites or pods owned or managed by cloud DC operator(s). Those cloud internal sites or pods are not visible to the clients using the cloud services. Enterprise clients usually have their own Customer Premises Equipment (CPEs) connecting to the cloud GWs or virtual GWs using private paths over the public Internet.

There are many available operations, administration and management (OAM) and diagnostics tools for the enterprise's CPEs to detect connectivity and performance to the cloud GW. However, network layer OAM cannot detect failure or degradation of the cloud site/pod attached to the cloud GW.

When a failure event occurs, the cloud DC GW that is visible to clients is usually operating as normal. Therefore, the client GW cannot use bidirectional forwarding detection (BFD) to detect the failures. When a site capacity degrades or goes dark, there are massive numbers of routes needing to be changed.

### SUMMARY

A first aspect relates to a method implemented by a gateway of a cloud data center. The method includes sending a first Border Gateway Protocol (BGP) UPDATE message that includes a site-reference identifier (ID) corresponding to a group of routes within a site of the cloud data center; determining that an operating capacity change affecting the group of routes within the site has occurred; and sending a second BGP UPDATE message that includes operating capacity information of the site reflecting the operating capacity change.

Optionally, in a first implementation according to the first aspect, the operating capacity information indicates an operating capacity percentage of the site.

Optionally, in a second implementation according to the first aspect or implementation thereof, the group of routes is all routes within the site.

Optionally, in a third implementation according to the first aspect or implementation thereof, the site-reference ID is included in a Site-Capacity Opaque Extended Community attribute in the first BGP UPDATE message.

Optionally, in a fourth implementation according to the first aspect or implementation thereof, the site-reference ID is included in a Metadata path attribute in the first BGP UPDATE message.

Optionally, in a fifth implementation according to the first aspect or implementation thereof, the operating capacity information is included in a Site-Capacity Opaque Extended Community attribute in the second BGP UPDATE message.

Optionally, in a sixth implementation according to the first aspect or implementation thereof, the operating capacity information is included in a Metadata path attribute in the second BGP UPDATE message.

Optionally, in a seventh implementation according to the first aspect or implementation thereof, the method further includes monitoring for a subsequent operating capacity change of the site; determining that the subsequent operating capacity change occurs; and sending a subsequent BGP UPDATE message that includes subsequent operating capacity information of the site corresponding to the subsequent operating capacity change.

Optionally, in an eighth implementation according to the first aspect or implementation thereof, the subsequent capacity change further decreases the capacity of the site.

Optionally, in a ninth implementation according to the first aspect or implementation thereof, the subsequent capacity change increases the capacity of the site.

A second aspect relates to a method implemented by an ingress router of a cloud data center. The method includes receiving a first Border Gateway Protocol (BGP) UPDATE message that includes a site-reference identifier (ID) corresponding to a group of routes within a site of the cloud data center; attaching the site-reference ID to the group of routes in a routing table; receiving a second BGP UPDATE message that includes operating capacity information; selecting a path for forwarding traffic corresponding to the group of routes based on the operating capacity information; and forwarding traffic for selected services along the path.

Optionally, in a first implementation according to the second aspect, wherein selecting a path for forwarding traffic corresponding to the group of routes comprises computing a first cost of the path based on a plurality of factors including the operating capacity information; and comparing the first cost of the path to a second cost of a second path.

Optionally, in a second implementation according to the second aspect or implementation thereof, the plurality of factors comprises a load index, a capacity index, a network latency measurement, and a preference index.

Optionally, in a third implementation according to the second aspect or implementation thereof, wherein forwarding traffic for selected services along the path comprises performing a lookup of the group of routes in a forwarding information base (FIB) to obtain a destination prefix.

Optionally, in a fourth implementation according to the second aspect or implementation thereof wherein forwarding traffic for selected services along the path comprises forwarding packets from a same flow to a same egress router.

Optionally, in a fifth implementation according to the second aspect or implementation thereof, the operating capacity information indicates an operating capacity percentage of the site.

Optionally, in a sixth implementation according to the second aspect or implementation thereof, the group of routes is all routes within the site

Optionally, in a seventh implementation according to the second aspect or implementation thereof, the site-reference ID is included in a Site-Capacity Opaque Extended Community attribute in the first BGP UPDATE message.

Optionally, in an eighth implementation according to the second aspect or implementation thereof, the site-reference ID is included in a Metadata path attribute in the first BGP UPDATE message.

Optionally, in a ninth implementation according to the second aspect or implementation thereof, the operating capacity information is included in a Site-Capacity Opaque Extended Community attribute in the second BGP UPDATE message.

Optionally, in a tenth implementation according to the second aspect or implementation thereof, the operating capacity information is included in a Metadata path attribute in the second BGP UPDATE message.

A third aspect relates to a gateway router of a cloud data center, the gateway comprising a memory storing instructions; and one or more processors coupled to the memory and configured to execute the instructions to cause the gateway to: send a first Border Gateway Protocol (BGP) UPDATE message that includes a site-reference identifier (ID) corresponding to a group of routes within a site of the cloud data center; determine that an operating capacity change affecting the group of routes within of the site has occurred; and send a second BGP UPDATE message that includes operating capacity information of the site reflecting the operating capacity change.

Optionally, in a first implementation according to the third aspect, the operating capacity information indicates an operating capacity percentage of the site.

Optionally, in a second implementation according to the third aspect or implementation thereof, the group of routes is all routes within the site.

Optionally, in a third implementation according to the third aspect or implementation thereof, the site-reference ID is included in a Site-Capacity Opaque Extended Community attribute in the first BGP UPDATE message.

Optionally, in a fourth implementation according to the third aspect or implementation thereof, the site-reference ID is included in a Metadata path attribute in the first BGP UPDATE message.

Optionally, in a fifth implementation according to the third aspect or implementation thereof, the operating capacity information is included in a Site-Capacity Opaque Extended Community attribute in the second BGP UPDATE message.

Optionally, in a sixth implementation according to the third aspect or implementation thereof, the operating capacity information is included in a Metadata path attribute in the second BGP UPDATE message.

Optionally, in a seventh implementation according to the third aspect or implementation thereof, the method further includes monitoring for a subsequent operating capacity change of the site; determining that the subsequent operating capacity change occurs; and sending a subsequent BGP UPDATE message that includes subsequent operating capacity information of the site corresponding to the subsequent capacity change.

Optionally, in an eighth implementation according to the third aspect or implementation thereof, the subsequent capacity change further decreases the capacity of the site.

Optionally, in a ninth implementation according to the third aspect or implementation thereof, the subsequent capacity change increases the capacity of the site.

A fourth aspect relates to a router comprising a memory storing instructions; and one or more processors coupled to the memory and configured to execute the instructions to cause the router to: receive a first Border Gateway Protocol (BGP) UPDATE message that includes a site-reference identifier (ID) corresponding to a group of routes within a site of the cloud data center; attach the site-reference ID to the group of routes in a routing table; receive a second BGP UPDATE message that includes operating capacity information; select a path for forwarding traffic corresponding to the group of routes based on the operating capacity information; and forward traffic for selected services along the path.

Optionally, in a first implementation according to the fourth aspect, wherein selecting a path for forwarding traffic corresponding to the group of routes comprises computing a first cost of the path based on a plurality of factors including the operating capacity information; and comparing the first cost of the path to a second cost of a second path.

Optionally, in a second implementation according to the fourth aspect or implementation thereof, the plurality of factors comprises a load index, a capacity index, a network latency measurement, and a preference index.

Optionally, in a third implementation according to the fourth aspect or implementation thereof, wherein forwarding traffic for selected services along the path comprises performing a lookup of the group of routes in a forwarding information base (FIB) to obtain a destination prefix.

Optionally, in a fourth implementation according to the fourth aspect or implementation thereof wherein forwarding traffic for selected services along the path comprises forwarding packets from a same flow to a same egress router.

Optionally, in a fifth implementation according to the fourth aspect or implementation thereof, the operating capacity information indicates an operating capacity percentage of the site.

Optionally, in a sixth implementation according to the fourth aspect or implementation thereof, the group of routes is all routes within the site

Optionally, in a seventh implementation according to the fourth aspect or implementation thereof, the site-reference ID is included in a Site-Capacity Opaque Extended Community attribute in the first BGP UPDATE message.

Optionally, in an eighth implementation according to the fourth aspect or implementation thereof, the site-reference ID is included in a Metadata path attribute in the first BGP UPDATE message.

Optionally, in a ninth implementation according to the fourth aspect or implementation thereof, the operating capacity information is included in a Site-Capacity Opaque Extended Community attribute in the second BGP UPDATE message.

Optionally, in a tenth implementation according to the fourth aspect or implementation thereof, the operating capacity information is included in a Metadata path attribute in the second BGP UPDATE message.

A fifth aspect relates to a method implemented by a gateway of a cloud data center. The method includes determining that an operating capacity of the site has occurred; and sending a BGP UPDATE message that includes a site-reference identifier (ID) and the operating capacity information of the site, wherein the site-reference ID corresponds to a group of routes within a site of the cloud data center.

A sixth aspect relates to a method implemented by an ingress router of a cloud data center. The method includes receiving a Border Gateway Protocol (BGP) UPDATE message that includes a site-reference identifier (ID) and operating capacity information, wherein the site-reference ID corresponds to a group of routes within a site of the cloud data center; attaching the site-reference ID to the group of routes in a routing table; selecting a path for forwarding traffic corresponding to the group of routes based on the operating capacity information; and forwarding traffic for selected services along the path.

A seventh aspect relates to a network device comprising means for performing any of the preceding aspects or implementation thereof.

An eighth aspect relates to a computer program product comprising computer-executable instructions stored on a non-transitory computer-readable storage medium, the computer-executable instructions when executed by one or more processors of an apparatus, cause the apparatus to perform any of the preceding aspects or implementation thereof.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating a network according to an embodiment of the present disclosure.

FIG. 2 is a flowchart illustrating a process for advertising site capacity degradation according to an embodiment of the present disclosure.

FIG. 3 is a flowchart illustrating a process performed by an ingress router according to an embodiment of the present disclosure.

FIG. 4 is a Site-Capacity Opaque Extended Community attribute according to an embodiment of the present disclosure.

FIG. 5 is a metadata path attribute according to an embodiment of the present disclosure.

FIG. 6 is a site preference index sub-TLV according to an embodiment of the present disclosure.

FIG. 7 is a degradation index sub-TLV according to an embodiment of the present disclosure.

FIG. 8 is a schematic diagram of an apparatus according to an embodiment of the present disclosure.

### DESCRIPTION OF EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The present disclosure provides a mechanism to optimize processing when a large number of service instances are impacted by cloud site/pods encountering a failure or degradation. The disclosed mechanism not only significantly reduces the number of advertisements by the cloud GW for large number service instances to the impacted CPEs or ingress routers, but also accelerates the switching for large number of instances by the CPEs to the next optimal sites.

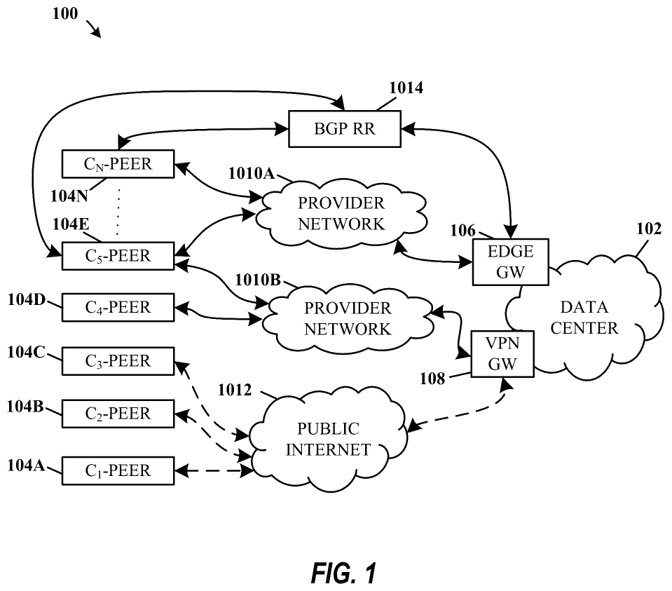

FIG. 1 is a schematic diagram illustrating a network 100 according to an embodiment of the present disclosure. The network 100 includes a data center 102 (often referred to as a cloud data center or the cloud) that hosts and provides a plurality of services. In an embodiment, the data center 102 is an edge DC that is managed by a cloud DC operator. An edge DC is a DC that is positioned closer to the edge of a network such that computing and storage resources are closer to the end-users or edge devices, thus reducing latency and improving the performance of applications and services. For instance, in an embodiment, the network 100 represents a single domain such as a 5G local data network, which is a limited domain with edge services a few hops away from the ingress nodes. As an example, the data center 102 may be connected to a plurality of customer premises equipment (CPE), labeled C₁-peer 104A-C_{N}-peer 104N, through an edge gateway 106 or a virtual private network (VPN) gateway 108. The edge gateway 106 and VPN gateway 108 are devices or routers that serves as a gateway or entry point for network traffic flowing into or out of the data center 102. In an embodiment, the C₁-peer 104A-C_{N}-peer 104N may be network devices (e.g., routers or client gateway devices) located at various branch offices of an enterprise that connect to the data center 102 for receiving services provided by the data center 102. One or more of the CPEs, C₁-peer 104A-C_{N}-peer 104N, may connect to the edge gateway 106 and VPN gateway 108 through one or more provider networks 1010A-1010B. Alternatively, in an embodiment, one or more of the CPEs, C₁-peer 104A-C_{N}-peer 104, may connect to the VPN gateway 108 over a public Internet 1012 using a secure tunnel (e.g., using Internet Protocol Security (IPsec)) to establish secure connection to the VPN gateway 108 (illustrated using dash arrows in FIG. 1). Although only one edge gateway 106 and VPN gateway 108 are illustrated in FIG. 1, the data center 102 may have multiple edge gateways 106 and VPN gateways 108. In the present disclosure, the CPEs, C₁-peer 104A-C_{N}-peer 104N, are referred to as ingress routers (or ingress nodes) because they connect to the data center 102 and represent the client-side connection. The one or more edge gateways 106 and VPN gateways 108 are referred to as egress routers (or egress nodes) and represent the server-side/DC connection. In an embodiment, the ingress routers and egress routers may establish a Border Gateway Protocol (BGP) session (e.g., using a BGP route reflector (RR) 1014) to exchange routing information. BGP is an inter-Autonomous System (AS) routing protocol used to exchange network reachability information with other BGP systems. In particular, BGP UPDATE messages are used for advertising and exchanging routing information between BGP neighbors. The routing information is used to determine the paths for communicating packets between the ingress routers and egress routers.

The data center 102 may include a plurality of server racks that houses all the servers at the data center 102. The data center 102 may include multiple sites (i.e., groups of hosts at distinct locations). Each site may be made up of multiple sections known as pods, which are easier to cool than one large room. Sometimes, one or more servers, server racks, pods, or sites may experience a failure, which may cause a site's operating capacity to degrade or an entire site to go down completely. Failures may be caused by a variety of reasons including, but not limited to, a fiber cut connecting to the site or among pods within the site, cooling failures, insufficient backup power, cyber threat attacks, and too many changes outside of the maintenance window. Currently, when a failure occurs at the data center 102, the egress routers of the data center 102 (e.g., edge gateway 106 and/or VPN gateway 108) visible to clients/ingress routers (e.g., C₁-peer 104A-C_{N}-peer 104N) may be operating normally. As a result, the ingress routers, which have paths to the egress routers, are not able to detect the failure at the data center using conventional BFD, which is a network protocol that is used to detect faults between two routers or switches connected by a link.

As stated above, when a site capacity degrades or goes dark, there are a massive number of routes that need to be changed. Additionally, the large number of routes switching over to another site can also cause overloading that triggers more failures. Further, the routes (Internet protocol (IP) addresses) in the data center 102 cannot be aggregated, triggering very large number of BGP UPDATE messages when a failure occurs. For example, currently, if 10,000 servers/hosts in the data center 102 fail (i.e., are no longer reachable), the egress router has to send 10,000 BGP UPDATE messages to affected ingress routers to notify the affected ingress routers that the routes to the hosts are no longer reachable so that the ingress routers can switch to a different site or perform other corrective actions.

To address the above issues, the present disclosure introduces a new metadata path attribute referred to as a site degradation index that indicates a degree of degradation that a site of a data center may be experiencing. By applying the disclosed embodiments, when a failure occurs at a site causing partial or total operating capacity loss, the egress router sends only a single BGP UPDATE message for all routes impacted. Ingress routers that receive the BGP UPDATE message can adjust the amount of traffic to the impacted site based on, along with other factors, the degree of degradation occurring at the site as indicated by the site degradation index in the received BGP UPDATE message.

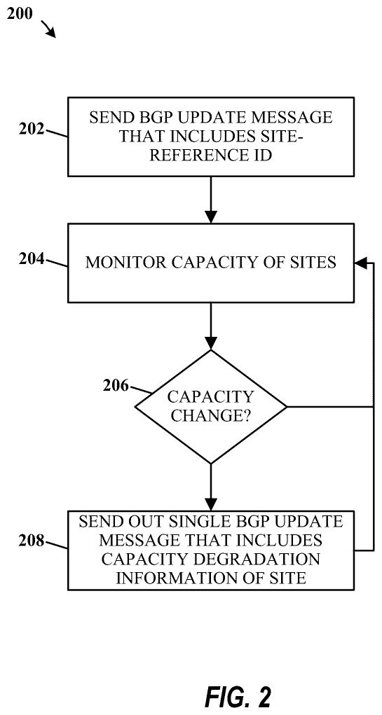

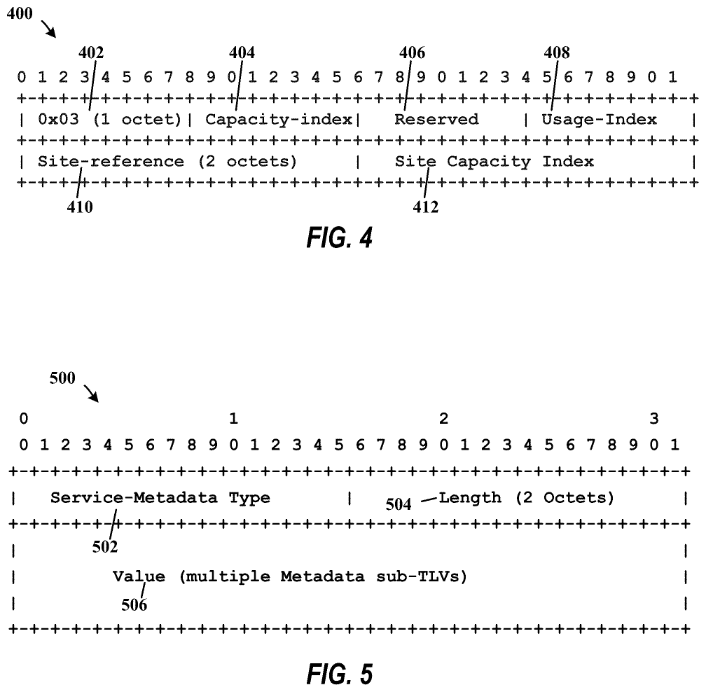

FIG. 2 is a flowchart illustrating a process 200 for advertising operating capacity of a site according to an embodiment of the present disclosure. An operating capacity of a site is an amount that the site is operating normally or functioning as intended. For example, an operating capacity of 100 means the site has full functioning capacity (i.e., no issues), whereas an operating capacity of 0 means the site is completely down. The process 200 may be performed by an egress router of a data center such as edge gateway 106 and/or VPN gateway 108 in FIG. 1. The egress router, at step 202, sends a BGP UPDATE message that includes a site-reference identifier (ID). In some embodiments, the site-reference ID represent a group of routes within one site/pod of the data center. In some embodiments, the site-reference ID may be a locally significant site/pod ID that represents the operating capacity for all the routes (instances) in the site/pod. There could be many sites/pods connected to the egress router to link the site-reference ID with a client route. In some embodiments, the site-reference ID is included in a Site-Capacity Opaque Extended Community attribute of BGP UPDATE messages that are periodically sent by the egress router. The Site-Capacity Opaque Extended Community attribute is an Opaque Extended Community attribute having a Capacity-index subtype as described below and illustrated in FIG. 4. The Opaque Extended Community attribute is defined in Internet Engineering Task Force (IETF) document Request for Comment (RFC) 4360 entitled “BGP Extended Communities Attribute” by S. Sangli et al., published February 2006. Alternatively, in some embodiments, the site-reference ID is included in a Metadata path attribute of BGP UPDATE messages sent by the egress router. A Metadata path attribute is BGP Path attribute having type Metadata as described below and illustrated in FIG. 5. BGP path attributes are used to provide more information (i.e., attributes) about each route such as weight, local preference, autonomous system (AS) path, etc. In some embodiments, the egress router does not include the site-reference ID in a BGP UPDATE message when there is no change to the site-reference ID for the client route from the site-reference ID sent out in a prior BGP UPDATE message. As further described below, the receiving ingress router attaches the site-reference ID to the routes in the routing table stored by the ingress router.

At step 204, the egress router monitors the operating capacity of the sites of the edge cloud to determine, at step 206, whether a site operating capacity in the edge cloud has changed (e.g., degraded or failed, or recovered from a previous failure) while the egress router is running as expected. For example, the egress router may determine that a portion of a site may not be reachable by regularly pinging the nodes in the edge cloud (and not receiving a response) or by monitoring the state of the links connecting the egress router to the nodes in the edge cloud. Other methods for determining the operating capacity of a site may be employed with the disclosed embodiments. In some embodiments, the egress router monitors does not actively perform the monitoring step 204, but instead discovers (e.g., unable to reach a certain node in the site) or obtains/identifies information indicating that an operating capacity of the site has changed.

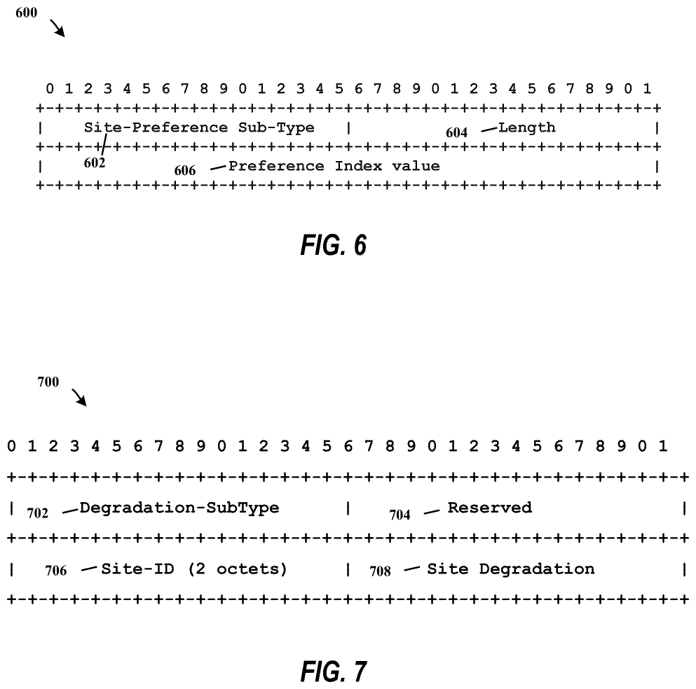

When the egress router determines that an operating capacity affecting the group of routes in the edge cloud has occurred (e.g., degraded or failed), the egress router, at step 208, sends out one BGP UPDATE message to advertise the operating capacity information of the site reflecting the operating capacity change. In some embodiments, the operating capacity information is included in the BGP UPDATE message using the Site-Capacity Opaque Extended Community attribute of FIG. 4. Alternatively, in some embodiments, the operating capacity information is included in the metadata path attribute of FIG. 5, which includes a degradation index sub-TLV that specifies a degree/level of degradation as described below and illustrated in FIG. 6. In some embodiments, the BGP UPDATE message may include additional path attributes such as, but not limited to, a site preference index or load measurement information. For example, a site preference index may be included in the BGP UPDATE message using the Preference Index sub-TLV described below and illustrated in FIG. 7. It should be noted that the site-reference ID and/or operating capacity information may be encoded in the BGP UPDATE message in other ways such as in other types of BGP communities (e.g., a BGP wide community). The present disclosure are not limited to a particular encoding scheme.

Additionally, in some embodiments, the site-reference ID may be included in the same BGP UPDATE message containing the operating capacity information. In these embodiments, the egress router does not need to send out a separate BGP UPDATE message containing the site-reference ID. Thus, in some embodiments, when the egress router (i.e., gateway of a cloud data center) determines that the operating capacity of the site has changed, the egress router sends a BGP UPDATE message that includes a site-reference identifier (ID) and the operating capacity information of the site.

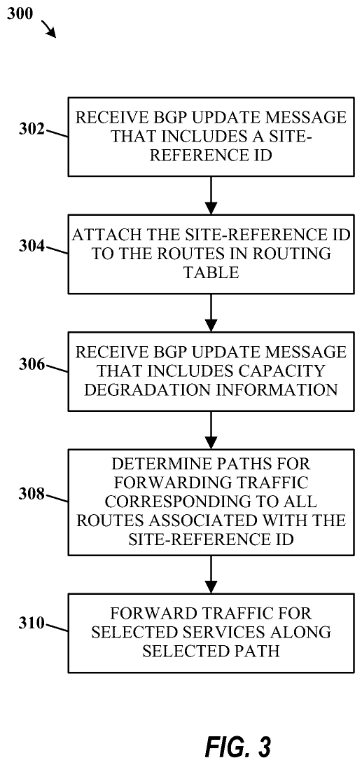

The ingress routers that receive the BGP UPDATE message utilizes the operating capacity information, along with any other path attribute information, to reroute traffic as described below in FIG. 3. This single BGP UPDATE message effectively achieves switching mass number of client routes from the degraded sites to other sites, and thus eliminates the need to send many BGP UPDATE messages to advertise the reduced capacity, and therefore optimizes mass switching triggered by a site failure or degradation of a cloud DC.

In some embodiments, the process 200 returns to step 204 and continues to monitor the operating capacity of the sites of the edge cloud. When the egress router determines, at step 206, that the operating capacity of a site of the edge cloud has changed (e.g., further degradation of a previously reported site or degradation of a different site, or the degradation capacity of a previously reported site has improved), the egress router, at step at step 208, sends out one BGP UPDATE message to advertise the new operating capacity information.

FIG. 3 is a flowchart illustrating a process 300 performed by an ingress router according to an embodiment of the present disclosure. The ingress router, at step 302, receives a BGP UPDATE message that includes a site-reference ID that represents a group of routes within one site/pod of the data center or all the routes (instances) in the site/pod. The ingress router, at step 304, attaches the site-reference ID to the routes in the routing table stored at the ingress router.

At step 306, the ingress router receives a BGP UPDATE message that includes operating capacity information from an egress router of an edge cloud DC. The ingress router may receive a BGP UPDATE message (with or without operating capacity information) from multiple egress routers of the edge cloud DC or egress routers of other cloud DC since most applications today have multiple server instances instantiated at different regions or different edge DCs. The ingress router will usually have multiple paths to reach the desired service instances. When the ingress router receives BGP UPDATE messages for the same IP address from multiple egress routers, all those egress routers are considered as the potential paths (or next hops) for the IP address (i.e., if the BGP Add Path is supported).

In some embodiments, for selected or affected services, the ingress router, at step 308, uses the operating capacity information from the one or more BGP UPDATE messages, along with other factors, to determine paths for forwarding traffic corresponding to all routes that are associated with the site-reference ID specified in the BGP UPDATE messages. For example, in some embodiments, the ingress router may call a function (referred to herein as a cost compute engine) that can select paths based on the cost associated with the routes based on, but not limited to, the site-degradation index, site preference index, and other network cost factors. For example, suppose a destination address for S1:aa08::4450 can be reached by three next hops (R1, R2, R3). Further, suppose the cost compute engine identifies R1 as the optimal next hop for flows to be sent to this destination (S1:aa08::4450). The cost compute engine can insert a higher weight for the tunnel associated with R1 for the prefix via the tunnel.

As a non-limiting example, in some embodiments, the cost compute engine computes the cost to reach the application servers attached to Site-i relative to a reference site, say Site-b based on the below formula.

$$Cost - i = ( w * ( \frac{CP - b * Load - i}{CP - i * Load - b} ) + ( 1 - w ) * ( \frac{Pref - b * Network - Delay - i}{Pref - i * Network - Delay - b} ) )$$

Load-i represents the load index at Site-i, which is the weighted combination of the total packets or/and bytes sent to and received from the application server at Site-i during a fixed time period.

CP-i represents the operating capacity index at Site-i. A higher CP-i value means a higher operating capacity.

Delay-i represents the network latency measurement (RTT) to the egress router associated with the application server at Site-i.

Pref-i represents the preference index for the Site-i. A higher preference index value means higher preference.

w represents the weight for load and site information, which is a value between 0 and 1. For example, if w is less than 0.5, network latency and the site preference have more influence; if w is greater than 0.5, server load and operating capacity have more influence, and if w is equal to 0.5, then network latency and the site preference have equal influence to server load and operating capacity.

When the reference site, Site-b, is plugged in the above formula, the cost is 1. So, if the formula returns a value less than 1 for Site-i, the cost to reach Site-i is less than the cost of reaching Site-b.

At step 310, the ingress router forwards traffic for the selected services along the selected path. For example, when the ingress router receives a packet, the ingress router performs a lookup of the route in a forwarding information base (FIB) to obtain the destination prefix's whole path. The ingress router then encapsulates the packet destined towards the optimal egress node. For subsequent packets belonging to the same flow, the ingress router forwards them to the same egress router unless the selected egress router is no longer reachable. Keeping packets from one flow to the same egress router, a.k.a., flow affinity, is supported by many commercial routers.

As stated above, in some embodiments, the site-reference ID may be included in the same BGP UPDATE message containing the operating capacity information. In these embodiments, the ingress router receives a BGP UPDATE message containing the site-reference ID and the operating capacity information of the site. The ingress router attaches the site-reference ID to the group of routes in a routing table. The ingress router then selects a path for forwarding traffic corresponding to the group of routes based on the operating capacity information. For selected services, the ingress router forwards traffic along the selected path.

FIG. 4 is a Site-Capacity Opaque Extended Community attribute 400 according to an embodiment of the present disclosure. The Site-Capacity Opaque Extended Community attribute 400 includes a type field 402, a subtype field 404, a reserve field 406, a usage-index field 408, a site reference field 410, and a site capacity index field 412. The type field 402 is a 1-octet field that contains the value=0x03 to indicate that the type is an Opaque Extended community type. Subtype field 404 is a 1-octet field indicating a capacity-index subtype. The reserve field 406 is a 1-octet field that is reserved for future use. The usage-index field 408 is a 1-octet field indicating if the site capacity index is an absolute value, relative to all the sites/pods attached to the BGP speaker, or percentage, etc. The site-reference field 410 is a 2-octet field that specifies a site-reference ID as described above. The site capacity index field 412 specifies an operating capacity index representing the percentage of the site's operating capacity. In an embodiment, the capacity index is a value between 0 and 100. For example, when a site goes dark, the operating capacity index is set to 0. Similarly, an operating capacity index of 50 means the site has 50% functioning capacity, and an operating capacity index of 100 means the site has 100% functioning capacity (i.e., no issues). Unless a site goes dark (i.e., zero working capacity), not all traffic to the site needs to be rerouted.

FIG. 5 is a metadata path attribute 500 according to an embodiment of the present disclosure. In some embodiments, the metadata path attribute 500 is an optional transitive BGP Path attribute that carries edge service metadata. The metadata path attribute 500 comprises a service-metadata type field 502, a length field 504, and a value field 506. The service-metadata type field 502 is a two-octets size field that carries a value of the type code (to-be-determined (TBD) by the Internet Assigned Numbers Authority (IANA)) indicating that the type-length-value (TLV) is a metadata path attribute. The length field 504 is a two-octets size field that carries a value indicating the total number of octets (i.e., size) of the value field 506. The value field 506 comprises a set of sub-TLVs (i.e., one or more sub-TLVs), with each sub-TLV containing information corresponding to a different/specific metric of the edge service metadata. In an embodiment, all values in the sub-TLVs are unsigned 32 bit integers. Examples of metrics of the edge service metadata include, but are not limited to, a capacity index value, a site preference index value, and a load measurement value.

FIG. 6 is a site preference index sub-TLV 600 according to an embodiment of the present disclosure. In an embodiment, the site preference index sub-TLV 600 is a sub-TLV that may be carried in the value field 506 of the metadata path attribute 500 in FIG. 5 for specifying a site preference index of an edge cloud site. The site preference index sub-TLV 600 comprises a site-preference sub-type field 602, a length field 604, and a preference index value field 606. The site-preference sub-type field 602 is a two-octets size field that carries a value of the type code (TBD) indicating that the sub-TLV is a site preference index. The length field 604 is a two-octets size field that carries a value indicating the total number of octets (i.e., size) of the preference index value field 606. The preference index value field 606 carries a site preference index value. In an embodiment, the site preference index value is a value between 1-100, with 1 being the least preferred, and 100 being the most preferred.

The site preference index may be based on various factors. For example, one edge cloud site can have fewer computing servers, less power, or lower internal network bandwidth than another edge cloud site. In an embodiment, an edge site located at a remote cell site may have a lower preference index value than an edge site in a metro area that hosts management systems, analytics functions, and security functions. As described above, in some embodiments, the site preference index is one of the factors integrated into the total cost for path selection.

FIG. 7 is a degradation index sub-TLV 700 according to an embodiment of the present disclosure. The degradation index sub-TLV 700 comprises a degradation-subtype field 702, a reserved field 704, a site-ID field 706, and a site degradation field 708. The degradation-subtype field 702 is a two-octets size field that carries a value of the type code (TBD) indicating that the sub-TLV is a degradation index type. The reserved field 704 is a two-octets size field that is reserved for future use. The site ID field 706 is a two-octets size field that carries a site-reference ID for a group of routes whose operating capacity is indicated by the operating capacity value carried in a BGP UPDATE message. The site degradation field 708 is a two-octets size field that carries an operating capacity value (e.g., between 1-100) representing the percentage of the site's operating. For instance, a value of 100 represents 100% or full capacity, 50 represents half capacity (e.g., 50% degraded), 25 represents a quarter capacity, and 0 represents no capacity or complete site failure (i.e., the site is completely dark).

In some embodiments, when an ingress router receives a BGP Update message from Router-X with the degradation index sub-TLV 700 without routes attached, the site degradation value indicated in the site degradation field 708 is applied to all routes that have the Router-X as their next hops and are associated with the site-reference ID specified in the site ID field 706.

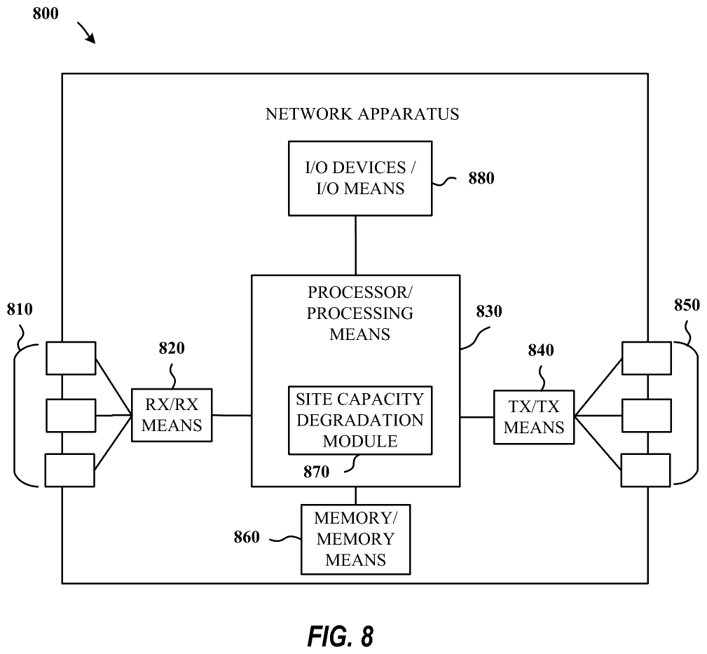

FIG. 8 is a schematic diagram of a network apparatus 800 (e.g., a network node, a network router, a router, etc.). The network apparatus 800 is suitable for implementing the disclosed embodiments as described herein. In an embodiment, the network apparatus 800 may be an egress router (e.g., edge gateway 106) or an ingress router (e.g., C1-peer 104A-CN-peer 104N). The network apparatus 800 comprises ingress ports/ingress means 810 (a.k.a., upstream ports) and receiver units (Rx)/receiving means 820 for receiving data; a processor, logic unit, or central processing unit (CPU)/processing means 830 to process the data; transmitter units (Tx)/transmitting means 840 and egress ports/egress means 850 (a.k.a., downstream ports) for transmitting the data; and a memory/memory means 860 for storing the data. The network apparatus 800 may also comprise optical-to-electrical (OE) components and electrical-to-optical (EO) components coupled to the ingress ports/ingress means 810, the receiver units/receiving means 820, the transmitter units/transmitting means 840, and the egress ports/egress means 850 for egress or ingress of optical or electrical signals.

The processor/processing means 830 is implemented by hardware and software. The processor/processing means 830 may be implemented as one or more CPU chips, cores (e.g., as a multi-core processor), field-programmable gate arrays (FPGAs), application specific integrated circuits (ASICs), and digital signal processors (DSPs). The processor/processing means 830 is in communication with the ingress ports/ingress means 810, receiver units/receiving means 820, transmitter units/transmitting means 840, egress ports/egress means 850, and memory/memory means 860. The processor/processing means 830 comprises a site capacity degradation module 870. The site capacity degradation module 870 is able to implement the methods disclosed herein. The inclusion of the site capacity degradation module 870 therefore provides a substantial improvement to the functionality of the network apparatus 800 and effects a transformation of the network apparatus 800 to a different state. Alternatively, the site capacity degradation module 870 is implemented as instructions stored in the memory/memory means 860 and executed by the processor/processing means 830.

The network apparatus 800 may also include input and/or output (I/O) devices or I/O means 880 for communicating data to and from a user. The I/O devices or I/O means 880 may include output devices such as a display for displaying video data, speakers for outputting audio data, etc. The I/O devices or I/O means 880 may also include input devices, such as a keyboard, mouse, trackball, etc., and/or corresponding interfaces for interacting with such output devices.

The memory/memory means 860 comprises one or more disks, tape drives, and solid-state drives and may be used as an over-flow data storage device, to store programs when such programs are selected for execution, and to store instructions and data that are read during program execution. The memory/memory means 860 may be volatile and/or non-volatile and may be read-only memory (ROM), random access memory (RAM), ternary content-addressable memory (TCAM), and/or static random-access memory (SRAM).

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

While several embodiments have been provided in the present disclosure, it should be understood that the disclosed systems and methods might be embodied in many other specific forms without departing from the spirit or scope of the present disclosure. For example, the disclosed embodiments include a computer program product comprising computer-executable instructions stored on a non-transitory computer-readable storage medium, the computer-executable instructions when executed by a processor of an apparatus, cause the apparatus to perform the methods disclosed herein. A person skilled in the art would understand how to combine any or all of the above techniques in a vast variety of permutations and combinations.

It should be noted that the disclosed embodiments may apply not only to 5G edge networks, but also to other environments such as, but not limited to, storage clusters at remote sites, data centers, cloud DC, pods, and enterprise networks that have large number of devices failure not detectable from the source.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented by an egress router of a cloud data center, the method comprising:
sending a first Border Gateway Protocol (BGP) UPDATE message comprising a site-reference identifier (ID) corresponding to a group of routes within a site of the cloud data center;
determining that an operating capacity change affecting the group of routes within the site has occurred; and
sending a second BGP UPDATE message comprising the site-reference ID and operating capacity information of the site reflecting the operating capacity change.

2. The method according to claim 1, wherein the operating capacity information indicates an operating capacity percentage of the site.

3. The method of claim 1, wherein the group of routes is all routes within the site.

4. The method of claim 1, wherein the second BGP UPDATE message comprises an Opaque Extended Community attribute that carries the site-reference ID and the operating capacity information.

5. The method of claim 1, wherein the second BGP UPDATE message comprises a type-length-value (TLV) that carries the site-reference ID and the operating capacity information.

6. The method of claim 1, wherein at least one of the first BGP UPDATE message or the second BGP UPDATE message comprises an optional transitive BGP Path attribute that carries one or more site preference values for path selection.

7. The method of claim 1, further comprising:
monitoring for a subsequent operating capacity change of the site;
determining that the subsequent operating capacity change occurs; and
sending a third BGP UPDATE message that includes the site-reference ID and subsequent operating capacity information of the site corresponding to the subsequent operating capacity change.

8. The method according to claim 7, wherein the subsequent operating capacity change further decreases the operating capacity of the site.

9. The method according to claim 7, wherein the subsequent operating capacity change increases the operating capacity of the site.

10. A method implemented by an ingress router of a cloud data center, the method comprising:
receiving a first Border Gateway Protocol (BGP) UPDATE message comprising a site-reference identifier (ID) corresponding to a group of routes within a site of the cloud data center;
attaching the site-reference ID to the group of routes in a routing table;
receiving a second BGP UPDATE message comprising the site-reference ID and operating capacity information;
selecting a path for forwarding traffic corresponding to the group of routes based on the operating capacity information; and
forwarding traffic for selected services along the path.

11. The method according to claim 10, wherein selecting a path for forwarding traffic corresponding to the group of routes comprises:
computing a first cost of the path based on a plurality of factors, wherein the plurality of factors comprises the operating capacity information; and
comparing the first cost of the path to a second cost of a second path.

12. The method according to claim 11, wherein the plurality of factors further comprises a load index, a capacity index, a network latency measurement, and a preference index.

13. The method according to claim 11, wherein at least one of the first BGP UPDATE message or the second BGP UPDATE message comprises the plurality of factors.

14. The method of claim 10, wherein forwarding traffic for selected services along the path comprises performing a lookup of the group of routes in a forwarding information base (FIB) to obtain a destination prefix.

15. The method of claim 10, wherein forwarding traffic for selected services along the path comprises forwarding packets from a same flow to a same egress router.

16. A network device comprising:
a memory storing instructions; and
one or more processors coupled to the memory and configured to execute the instructions to cause the network device to:
send a first Border Gateway Protocol (BGP) UPDATE message comprising a site-reference identifier (ID) corresponding to a group of routes within a site of a cloud data center;
determine that an operating capacity change affecting the group of routes within the site has occurred; and
send a second BGP UPDATE message comprising the site-reference ID and operating capacity information of the site reflecting the operating capacity change.

17. The network device of claim 16, wherein the operating capacity information indicates an operating capacity percentage of the site.

18. The network device of claim 16, wherein at least one of the first BGP UPDATE message or the second BGP UPDATE message comprises one or more site preference values for path selection.

19. The network device of claim 16, further comprising:
monitoring for a subsequent operating capacity change of the site;
determining that the subsequent operating capacity change occurs; and
sending a third BGP UPDATE message that includes subsequent operating capacity information of the site corresponding to the subsequent operating capacity change.

20. The network device according to claim 19, wherein the subsequent operating capacity change further decreases the operating capacity of the site.
